(19) United States
(12) Patent Application Publication
(10) Pub. No.: US 2007/0143692 A1
(43) Pub. Date: Jun. 21, 2007

(54) Multi-type field processing in a Wiki page

(75) Inventors: Michael Muller, Medford, MA (US); Jonathan Feinberg, Medford, MA (US); Sandra L. Kogan, Newton, MA (US); Eric M. Wilcox, Winchester, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/314,985

(22) Filed: Dec. 21, 2005

(51) Int. Cl. G06F 17/00

(52) U.S. Cl. 715/751

(57) ABSTRACT

Embodiments of the present invention address deficiencies of the art in respect to Wiki page processing and provide a novel and non-obvious method, system and computer program product for multi-type field processing in a Wiki page. In one embodiment of the invention, a data processing system configured to serve Wiki pages, the data processing system can be provided. The system can include a content host configured with a Wiki server, and multi-field editing logic coupled to the Wiki server. The multi-field editing logic can include program code enabled to edit at least two different fields in a Wiki page. Moreover, each of the different fields can have correspondingly different field types wherein one of the field types is a dynamic access control list (ACL) limited editable field.

### BACKGROUND OF THE INVENTION

1. Field of the Invention

The present invention relates to the field of Wiki page processing and more particularly to editing fields in a Wiki page.

2. Description of the Related Art

Prior to the popularization of the Internet and the subsequent deployment of the World Wide Web, software publishers distributed content via storage media such as a computer diskette or compact disc. Recently, given the popularization of the Internet and the World Wide Web, the disk medium no longer is the preferred mode of distribution for electronic content. Rather, the Internet now serves as the principal medium of distribution for electronic content. In this regard, content can be created and distributed for viewing in a Web browser widely used as the preeminent tool for viewing content over the Internet.

Content distribution about the Internet provides a base form of electronic collaboration for groups of collaborators. Collaborative computing generally refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

Collaborative tools can be sophisticated in nature and, as such, can be out of reach for many collaborative groups. To address the expense of collaborative tools, low cost, low-tech solutions have been proposed, including Wiki. Wiki is a collaborative application that allows users to freely create and edit Web page content using any Web browser. Wiki supports hyperlinks and incorporates a simplified syntax for dynamically creating new Web pages and cross-links between pages. Notably, Wiki has been characterized as unusual among collaborative tools in that Wiki supports not only the contribution of editable content to a collaborative document, but also the organization of contributed content in a collaborative document.

Despite the impact of Wiki on collaborative computing efforts, Wiki is deficient in that only content of a singular type—a string field—can be edited in a Wiki page. Furthermore, access control has been wholly excluded from consideration from Wiki implementations. In many formalized collaborative environments, however, access control remains a bedrock principle of computing which cannot be discarded willy-nilly. Accordingly, Wiki has not yet been viewed as a quick and cost-effective collaborative tool suitable for deployment within the enterprise.

### BRIEF SUMMARY OF THE INVENTION

Embodiments of the present invention address deficiencies of the art in respect to Wiki page processing and provide a novel and non-obvious method, system and computer program product for multi-type field processing in a Wiki page. In one embodiment of the invention, a data processing system configured to serve Wiki pages, the data processing system can be provided. The system can include a content host configured with a Wiki server, and multi-field editing logic coupled to the Wiki server. The multi-field editing logic can include program code enabled to edit at least two different fields in a Wiki page. Moreover, each of the different fields can have correspondingly different field types, wherein one of the field types is a dynamic access control list (ACL) limited editable field.

In one aspect of the embodiment, the dynamic ACL limited editable field can include limited access specified by an initial editor of the dynamic ACL limited editable field. In another aspect of the embodiment, at least one of the different fields can include a non-editable field enabled to be edited only by an initial author of the Wiki page. In yet another aspect of the embodiment, another of the different fields can include an editable text field.

In another embodiment of the invention, a method for multi-type field processing in a Wiki page can include configuring a Wiki page with at least two different fields having correspondingly different field types, wherein one of the field types is an ACL limited editable field, and providing the Wiki page to a content browser for rendering in the content browser. Configuring a Wiki page with at least two different fields having correspondingly different field types, can include configuring a Wiki page with a non-editable field enabled to be edited only by an initial author of the Wiki page. Finally, configuring a Wiki page with at least two different fields having correspondingly different field types, further can include configuring a Wiki page with an editable text field.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative environment configured with a Wiki tool enabled for multi-type field processing; and,

FIG. 2 is a flow chart illustrating a process for multi-type field processing in a Wiki page.

### DETAILED DESCRIPTION OF THE INVENTION

Embodiments of the present invention provide a method, system and computer program product for multi-type field processing in a Wiki page. In accordance with an embodiment of the present invention, a Wiki page can be configured to include at least two different editable fields of different types. Preferably, one of the editable fields can include a dynamic ACL limited field. In the present invention, the editability of a dynamic ACL limited field can be limited by the initial editor of the field. In this regard, the initial editor of the dynamic ACL limited field can apply access control limitations to the field which can be enforced for subsequent editors of the field. Consequently, a Wiki page configured with a dynamic ACL managed field can satisfy the access control requirements of the enterprise environment.

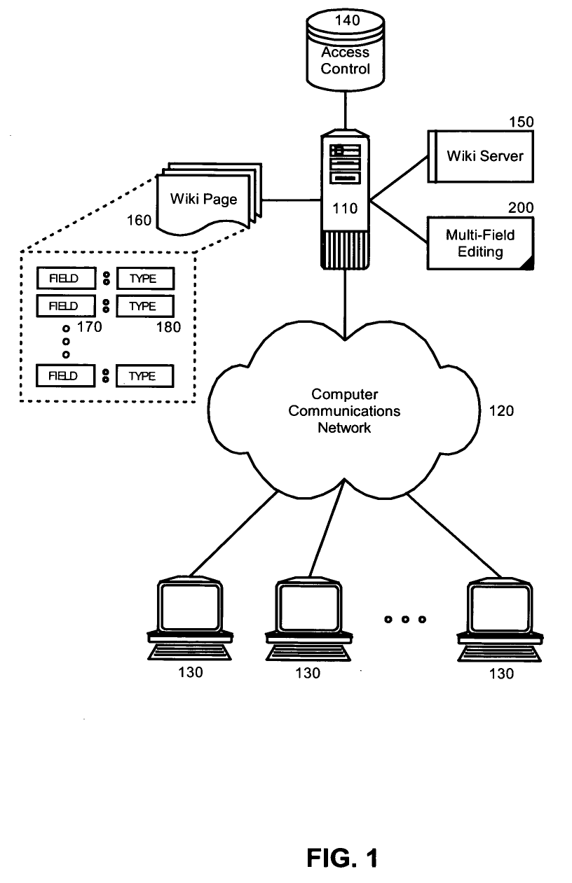

In illustration of an embodiment of the invention, FIG. 1 is a schematic illustration of a collaborative environment configured with a Wiki tool enabled for multi-type field processing. The collaborative environment can include a content host 110 configured to provide content on demand by requesting browser clients 130 over a computer communications network 120. The content host 110 can include a Wiki server 150 enabled to support the distribution of Wiki pages 160 to the browser clients 130. Notably, each of the Wiki pages 160 can be configured to include at least two different editable fields 170 having correspondingly different field types 180. The field types 180 can include editable text and ACL restricted editable text. Each of the editable fields 170 can be arranged in separate controls in the Wiki page 160, or in the same control in the Wiki page 160, each editable field 170 being separated by a delimiter.

In the case of ACL restricted editable text, a field among the fields 170 can be disposed in a page among the Wiki pages 180 which can accept editable text. An initial editor of the field can be prompted to apply ACL limitations for subsequent editors of the field. The ACL limitations can include read-only access, read-write access and delete access for different users or roles, to name only a few. Subsequent editors of the ACL restricted editable text are bound to the ACL limitations defined by the initial editor. The ACL limitations themselves can be enforced by access control program code within multi-type field editing logic 200 coupled to the Wiki server 150.

In one aspect of the invention, a field among the fields 170 also can include a non-editable text field. The non-editable text field can be created within the Wiki page 160 by the initial author of the Wiki page 160. The non-editable text field subsequently cannot be edited, albeit ACL limitations can be defined for the non-editable text field to permit the initial author of the Wiki page 160 to edit the non-editable text field at a later time. For instance, an edit operation can be provided to the initial author of the Wiki page 160, whereas the same edit operation is not provided to other viewers of the Wiki page 160.

More specifically, the multi-type field editing logic 200 can include program code enabled to manage the editing of the fields 170 in the Wiki pages 160, irrespective of the field types 180 for the fields 170. In this regard, the program code can be enabled to permit conventional interactions with an editable one of the fields 170, and the program code be enabled to permit ACL limited interactions with a dynamic ACL limited field. In the latter circumstance, the multi-type field editing logic 200 can refer to coupled access control data 140 to manage ACL limited interactions with a dynamic ACL restricted field.

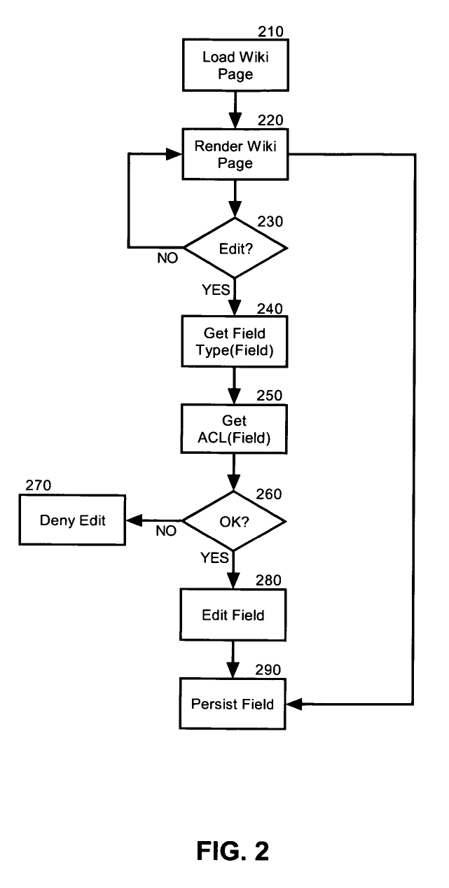

In further illustration, FIG. 2 is a flow chart illustrating a process for multi-type field processing in a Wiki page. Beginning in block 210, a Wiki page can be loaded for distribution to a content browser. The Wiki page can include at least two, multi-type fields. In block 220, the content browser can render the Wiki page. Subsequently, in decision block 230, if a field is selected for editing, in decision block 240 the field type can be retrieved for the selected field. The field type can include, for example, an editable field and an ACL limited editable field.

In block 250, ACL limitations, if any, can be retrieved for the selected field. The limitations can range from no access where the content of the selected field is obscured, to read-only access only, to full read and write access. In decision block 260, if the ACL limitations do not permit the editing of the selected field, in block 270, the attempt to edit the selected field can be denied. Otherwise, in block 280 the field can be edited. Subsequently, when the editing is complete, in block 290 the field can be persisted in the Wiki page as edited and the Wiki page can be re-rendered in block 220. As such, the process can repeat through decision block 230.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system configured to serve Wiki pages, the data processing system comprising:
a content host configured with a Wiki server; and,
multi-field editing logic coupled to the Wiki server, the multi-field editing logic comprising program code enabled to edit at least two different fields in a Wiki page, the different fields having correspondingly different field types, wherein at least one of the different fields comprises a dynamic access control list (ACL) limited editable field.

2. The system of claim 1, wherein at least one of the different fields comprises a non-editable field enabled to be edited only by an initial author of the Wiki page.

3. The system of claim 1, wherein another of the different fields comprises an editable text field.

4. The system of claim 1, wherein the dynamic ACL limited editable field comprises limited access specified by an initial editor of the dynamic ACL limited editable field.

5. A method for multi-type field processing in a Wiki page, the method comprising:
configuring a Wiki page with at least two different fields having correspondingly different field types, at least one of the different field types comprising a dynamic access control list (ACL) limited editable field; and,
providing the Wiki page to a content browser for rendering in the content browser.

6. The method of claim 5, wherein configuring a Wiki page with at least two different fields having correspondingly different field types, comprises configuring a Wiki page with a non-editable field enabled to be edited only by an initial author of the Wiki page.

7. The method of claim 5, wherein configuring a Wiki page with at least two different fields having correspondingly different field types, further comprises configuring a Wiki page with an editable text field.

8. A computer program product comprising a computer usable medium having computer usable program code for multi-type field processing in a Wiki page, said computer program product including:
computer usable program code for configuring a Wiki page with at least two different fields having correspondingly different field types, at least one of the different field types comprising a dynamic access control list (ACL) limited editable field; and,
computer usable program code for providing the Wiki page to a content browser for rendering in the content browser.

9. The computer program product of claim 8, wherein the computer usable program code for configuring a Wiki page with at least two different fields having correspondingly different field types, comprises computer usable program code for configuring a Wiki page with a dynamic access control list (ACL) limited editable field.

10. The computer program product of claim 8, wherein the computer usable program code for configuring a Wiki page with at least two different fields having correspondingly different field types, comprises computer usable program code for configuring a Wiki page with a non-editable field enabled to be edited only by an initial author of the Wiki page.

11. The computer program product of claim 8, wherein the computer usable program code for configuring a Wiki page with at least two different fields having correspondingly different field types, further comprises computer usable program code for configuring a Wiki page with an editable text field.
